(19) United States
(12) Patent Application Publication
(10) Pub. No.: US 2018/0112985 A1
(43) Pub. Date: Apr. 26, 2018

(54) Vision-Inertial Navigation with Variable Contrast Tracking Residual

(71) Applicant: The Charles Stark Draper Laboratory, Inc., Cambridge, MA (US)

(72) Inventor: Richard W. Madison, Bedford, MA (US)

(21) Appl. No.: 15/794,168

(22) Filed: Oct. 26, 2017

Related U.S. Application Data
(60) Provisional application No. 62/413,388, filed on Oct. 26, 2016.

(51) Int. Cl. G01C 21/16; G06K 9/62; G06T 7/277; G06T 7/246

(52) U.S. Cl. CPC G01C 21/165; G06K 9/6232; G06T 2207/30244; G06T 7/246; G06T 7/277

(57) ABSTRACT

A vision-aided inertial navigation system determines navigation solutions for a traveling vehicle. A feature tracking module performs optical flow analysis of the navigation images based on: detecting at least one image feature patch within a given navigation image comprising a plurality of adjacent image pixels corresponding to a distinctive visual feature, calculating a feature track for the at least one image feature patch across a plurality of subsequent navigation images based on calculating a tracking residual, and rejecting any feature track having a tracking residual greater than a feature tracking threshold criterion that varies over time with changes in quantifiable characteristics of the at least one feature patch. A multi-state constraint Kalman filter (MSCKF) analyzes the navigation images and the unrejected feature tracks to produce a time sequence of estimated image sensor poses characterizing estimated position and orientation of the image sensor for each navigation image.

This application claims priority to U.S. Provisional Patent Application 62/413,388, filed Oct. 26, 2016, which is incorporated herein by reference in its entirety.

### STATEMENT REGARDING FEDERALLY SPONSORED RESEARCH OR DEVELOPMENT

This invention was made with Government support under Contract Number W56KGU-14-C-00035 awarded by the U.S. Army (RDECOM, ACC-APG CERDEC). The U.S. Government has certain rights in the invention.

### TECHNICAL FIELD

The present invention relates to vision-aided inertial navigation.

### BACKGROUND ART

Odometry is the use of data from motion sensors to estimate changes in position over time. For example, a wheeled autonomous robot may use rotary encoders coupled to its wheels to measure rotations of the wheels and estimate distance and direction traveled along a factory floor from an initial location. Thus, odometry estimates position and/or orientation relative to a starting location. The output of an odometry system is called a navigation solution.

Visual odometry uses one or more cameras to capture a series of images (frames) and estimate current position and/or orientation from an earlier position and/or orientation by tracking apparent movement of features within the series of images. Image features that may be tracked include points, lines or other shapes within the image that are distinguishable from their respective local backgrounds by some visual attribute, such as brightness or color, as long as the features can be assumed to remain fixed, relative to a navigational reference frame, or motion of the features within the reference frame can be modeled, and as long as the visual attribute of the features can be assumed to remain constant over the time the images are captured, or temporal changes in the visual attribute can be modeled. Visual odometry is usable regardless of the type of locomotion used. For example, visual odometry is usable by aircraft, where no wheels or other sensors can directly record distance traveled. Further background information on visual odometry is available in Giorgio Grisetti, et al., “A Tutorial on Graph-Based SLAM,” IEEE Intelligent Transportation Systems Magazine, Vol. 2, Issue 4, pp. 31-43, Jan. 31, 2011, the entire contents of which are hereby incorporated by reference herein.

Vision-aided inertial navigation systems combine the use of visual odometry with inertial measurements to obtain an estimated navigational solution. For example, one approach uses what is known as multi-state constraint Kalman filter. See Mourikis, Anastasios I., and Stergios I. Roumeliotis. “A multi-state constraint Kalman filter for vision-aided inertial navigation.” Proceedings of the IEEE International Conference on Robotics and Automation. IEEE, 2007, which is incorporated herein by reference in its entirety.

### SUMMARY

Embodiments of the present invention are directed to a computer-implemented vision-aided inertial navigation system for determining navigation solutions for a traveling vehicle. An image sensor is configured for producing a time sequence of navigation images. An inertial measurement unit (IMU) is configured to generate a time sequence of inertial navigation information. A data storage memory is coupled to the image sensor and the inertial measurement sensor and is configured for storing navigation software, the navigation images, the inertial navigation information, and other system information. A navigation processor including at least one hardware processor is coupled to the data storage memory and is configured to execute the navigation software. The navigation software includes processor readable instructions to implement various software modules including a feature tracking module configured to perform optical flow analysis of the navigation images based on: a. detecting at least one image feature patch within a given navigation image comprising a plurality of adjacent image pixels corresponding to a distinctive visual feature, b. calculating a feature track for at least one image feature patch across a plurality of subsequent navigation images based on calculating a tracking residual, and c. rejecting any feature track having a tracking residual greater than a feature tracking threshold criterion that varies over time with changes in quantifiable characteristics of the at least one feature patch. A multi-state constraint Kalman filter (MSCKF) is coupled to the a feature tracking module and is configured to analyze both the unrejected feature tracks and the inertial navigation information from the IMU A strapdown inertial integrator is configured to analyze the inertial navigation information to produce a time sequence of estimated inertial navigation solutions representing changing locations of the traveling vehicle. A navigation solution module configured to analyze the image sensor poses and the estimated inertial navigation solutions to produce a time sequence of system navigation solution outputs representing changing locations of the traveling vehicle.

In further specific embodiments, the quantifiable characteristics of the at least one feature patch include pixel contrast for image pixels in the at least one feature patch. The feature tracking threshold criterion may include a product of a scalar quantity times a time-based derivative of the quantifiable characteristics; for example, the time-based derivative may be a first-order average derivative. Or the feature tracking threshold criterion may include a product of a scalar quantity times a time-based variance of the quantifiable characteristics. Or the feature tracking threshold criterion may include a product of a first scalar quantity times a time-based variance of the quantifiable characteristics in linear combination with a second scalar quantity accounting for at least one of image noise and feature contrast offsets.

### BRIEF DESCRIPTION OF THE DRAWINGS

FIG. 1 shows various functional blocks in a vision-aided inertial navigation system according to an embodiment of the present invention.

FIG. 2 shows an example of a pose graph representation of a time sequence of navigational images.

### DETAILED DESCRIPTION

Visual odometry as in a vision aided inertial navigation system involves analysis of optical flow, for example, using a Lucas-Kanade algorithm. Optical flow is the pattern of apparent motion of objects, surfaces, and edges in a visual scene caused by the relative motion between an observer (such as a camera) and the scene. This involves a two-dimensional vector field where each vector is a displacement vector showing the movement of points from first frame to second. Optical flow analysis typically assumes that the pixel intensities of an object do not change between consecutive frames, and that neighboring pixels have similar motion. Embodiments of the present invention modify the Lucas-Kanade optical flow method as implemented in a multi-state constraint Kalman filter (MSCKF) arrangement.

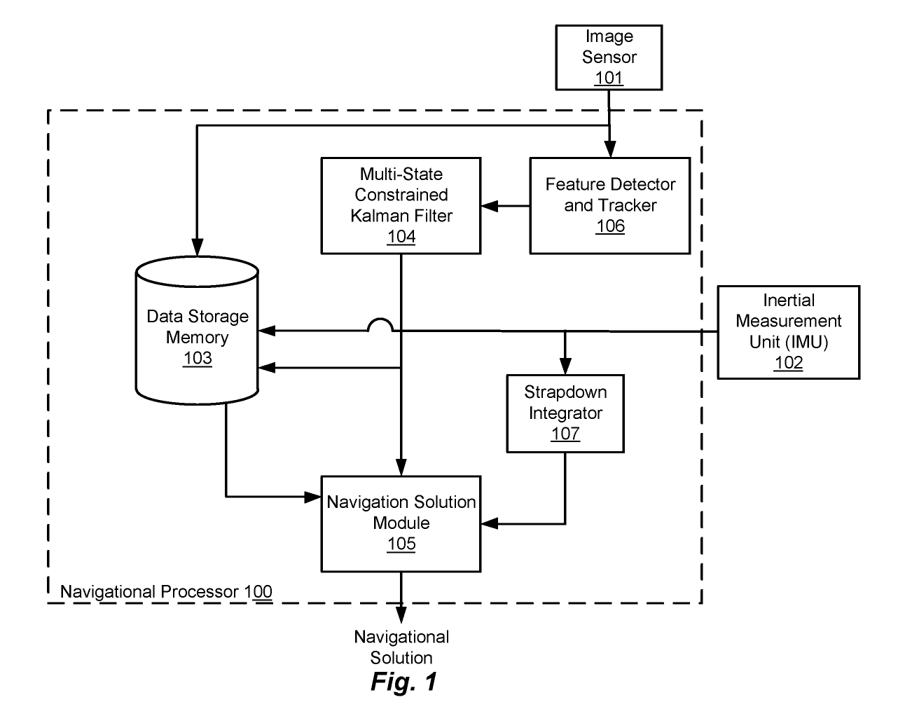

FIG. 1 shows various functional blocks in a vision-aided inertial navigation system according to an embodiment of the present invention. An image sensor 101 such as a monocular camera is configured for producing a time sequence of navigation images. Other non-limiting specific examples of image sensors 101 include high-resolution forward-looking infrared (FLIR) image sensors, dual-mode lasers, charge-coupled device (CCD-TV) visible spectrum television cameras, laser spot trackers and laser markers. An image sensor 101 such as a video camera in a typical application may be dynamically aimable relative to the traveling vehicle to scan the sky or ground for a destination (or target) and then maintain the destination within the field of view while the vehicle maneuvers. An image sensor 101 such as a camera may have an optical axis along which the navigation images represent scenes within the field of view. A direction in which the optical axis extends from the image sensor 101 depends on the attitude of the image sensor, which may, for example, be measured as rotations of the image sensor 101 about three mutually orthogonal axes (x, y and z). The terms “sensor pose” or “camera pose” mean the position and attitude of the image sensor 101 in a global frame. Thus, as the vehicle travels in space, the image sensor pose changes, and consequently the imagery captured by the image sensor 101 changes, even if the attitude of the image sensor remains constant

Data storage memory 103 is configured for storing navigation software, the navigation images, the inertial navigation information, and other system information. A navigation processor 100 includes at least one hardware processor coupled to the data storage memory 103 and is configured to execute the navigation software to implement the various system components. This includes performing optical flow analysis of the navigation images using a multi-state constraint Kalman filter (MSCKF) with variable contrast feature tracking, analyzing the inertial navigation information, and producing a time sequence of system navigation solution outputs representing changing locations of the traveling vehicle, all of which is discussed in greater detail below.

Starting with the navigation images from the image sensor 101, a pixel in first navigation image is defined by coordinates I(x,y,t) which move by a distance (dx, dy) in the next navigation image taken after some time dt. So since those pixels are the same and assuming their intensity does not change, then: I (x, y, t)=I (x+dx, y+dy, t+dt). Taking a Taylor series approximation of the right-hand side, removing common terms, and dividing by dt: fₓu+f_{y}v+fₜ=0, where:

$${f}_{x} = \frac{\partial f}{\partial x} ; {f}_{y} = \frac{\partial f}{\partial y} u = \frac{dx}{dt} ; v = \frac{dy}{dt}$$

which is known as the Optical Flow equation. Image gradients fₓ and f_{y} can be found, and fₜ is the gradient along time. But (u, v) is unknown and this one equation with two unknown variables is not solvable.

The Lucas-Kanade method is based on an assumption that all the neighboring pixels in an image feature will have similar motion. So a 3×3 image feature patch is taken around a given point in an image and all 9 points in the patch will have the same motion. The coordinates for these 9 points (fx, fy, ft) can be found by solving 9 equations with two unknown variables. That is over-determined and a more convenient solution can be obtained via a least square fit method, for example:

$$[ \begin{matrix}u \\ v\end{matrix} ] = {[ \begin{matrix}{\sum }_{i} {fx}_{i}^{2} & {\sum }_{i} {fx}_{i} {fy}_{i} \\ {\sum }_{i} {fx}_{i} {fy}_{i} & {\sum }_{i} {fy}_{i}^{2}\end{matrix} ]}^{- 1} [ \begin{matrix}- {\sum }_{i} {fx}_{i} {ft}_{i} \\ - {\sum }_{i} {fy}_{i} {ft}_{i}\end{matrix} ]$$

One specific implementation of Lucas-Kanade optical flow is set forth in OpenCV:

```
import numpy as np
import cv2
cap = cv2.VideoCapture(‘slow.flv’)
# params for ShiTomasi corner detection
feature_params = dict( maxCorners = 100,
    qualityLevel = 0.3,
    minDistance = 7,
    blockSize = 7 )
# Parameters for lucas kanade optical flow
lk_params = dict( winSize = (15,15),
    maxLevel = 2,
    criteria = (cv2.TERM_CRITERIA_EPS |
    cv2.TERM_CRITERIA_COUNT, 10, 0.03))
# Create some random colors
color = np.random.randint(0,255,(100,3))
# Take first frame and find corners in it
ret, old_frame = cap.read( )
old_gray = cv2.cvtColor(old_frame, cv2.COLOR_BGR2GRAY)
p0 = cv2.goodFeaturesToTrack(old_gray, mask = None,
**feature_params)
# Create a mask image for drawing purposes
mask = np.zeros_like(old_frame)
while(1):
    ret,frame = cap.read( )
    frame_gray = cv2.cvtColor(frame, cv2.COLOR_BGR2GRAY)
    # calculate optical flow
    p1, st, err = cv2.calcOpticalFlowPyrLK(old_gray, frame_gray, p0,
    None, **lk_params)
    # Select good points
    good_new = p1[st==1]
    good_old = p0[st==1]
    # draw the tracks
    for i,(new,old) in enumerate(zip(good_new,good_old)):
        a,b = new.ravel( )
        c,d = old.ravel( )
        mask = cv2.line(mask, (a,b),(c,d), color[i].tolist( ), 2)
        frame = cv2.circle(frame,(a,b),5,color[i].tolist( ),−1)
    img = cv2.add(frame,mask)
    cv2.imshow(‘frame’,img)
    k = cv2.waitKey(30) & 0xff
    if k == 27:
        break
    # Now update the previous frame and previous points
    old_gray = frame_gray.copy( )
    p0 = good_new.reshape(−1,1,2)
cv2.destroyAllWindows( )
cap.release( )
```

(from docs.opencv.org/3.2.0/d7/d8b/tutorial_py_lucas_kanade.html, which is incorporated herein by reference in its entirety).

The OpenCV version of the Lucas Kanade feature tracker can reject any tracks deemed failures by virtue of their tracking residual exceeding a user-specified threshold. That seems to work well on visible-light imagery. However in long-wavelength infrared (LWIR) imagery, the most useful features have very high contrast, such that even small and unavoidable misalignments between consecutive images produce high residuals, while failed matches between less useful, low contrast features produce low residuals. Thus in LWIR image, high residual does not reliably indicate a bad track and cannot be thresholded to detect bad tracks.

Embodiments of the present invention include a feature tracking detector 106 configured to implement a modified Lucas Kanade feature tracker to perform optical flow analysis of the navigation images. More specifically, an image feature patch is an image pattern that is unique to its immediate surroundings due to intensity, color and texture. The feature tracking detector 106 searches for all the point-features in each navigation image. Point-features such as blobs and corners (the intersection point of two or more edges) are especially useful because they can be accurately located within a navigation image. Point feature detectors include corner detectors such as Harris, Shi-Tomasi, Moravec and FAST detectors; and blob detectors such as SIFT, SURF, and CENSURE detectors. The feature tracking detector 106 applies a feature-response function to an entire navigation image. The specific type of function used is one element that differentiates the feature detectors (i.e. a Harris detector uses a corner response function while a SIFT detector uses a difference-of-Gaussian detector). The feature tracking detector 106 then identifies all the local minima or maxima of the feature-response function. These points are the detected features. The feature tracking detector 106 assigns a descriptor to the region surrounding each feature, e.g. pixel intensity, so that it can be matched to descriptors from other navigation images.

The feature tracking detector 106 detects at least one image feature patch within a given navigation image that includes multiple adjacent image pixels which correspond to a distinctive visual feature. To match features between navigation images, the feature tracking detector 106 specifically may compare all feature descriptors from one image to all feature descriptors from a second image using some kind of similarity measure (i.e. sum of squared differences or normalized cross correlation). The type of image descriptor influences the choice of similarity measure. Another option for feature matching is to search for all features in one image and then search for those features in other images. This “detect-then-track” method may be preferable when motion and change in appearance between frames is small. The set of all matches corresponding to a single feature is what is called an image feature patch (also referred to as a feature track). The feature tracking detector 106 calculates a feature track for the image feature patch across subsequent navigation images based on calculating a tracking residual, and rejecting any feature track that has a tracking residual greater than a feature tracking threshold criterion that varies over time with changes in quantifiable characteristics of the at least one feature patch.

The multi-state constraint Kalman filter (MSCKF) 104 is configured to analyze the navigation images and the unrejected feature tracks to produce a time sequence of estimated image sensor poses characterizing estimated position and orientation of the image sensor for each navigation image. The MSCKF 104 is configured to simultaneously estimate the image sensor poses for a sliding window of at least three recent navigation images. Each new image enters the window, remains there for a time, and eventually is pushed out to make room for newer images.

An inertial measurement unit (IMU) 102 (e.g. one or more accelerometers, gyroscopes, etc.) is a sensor configured to generate a time sequence of inertial navigation information. A strapdown integrator 107 is configured to analyze the inertial navigation information from the inertial sensor 102 to produce a time sequence of estimated inertial navigation solutions that represent changing locations of the traveling vehicle. More specifically, the IMU 102 measures and reports the specific force, angular rate and, in some cases, a magnetic field surrounding the traveling vehicle. The IMU 102 detects the present acceleration of the vehicle based on an accelerometer signal, and changes in rotational attributes such as pitch, roll and yaw based on one or more gyroscope signals. The estimated inertial navigation solutions from the strapdown integrator 107 represent regular estimates of the vehicle's position and attitude relative to a previous or initial position and attitude, a process known as dead reckoning.

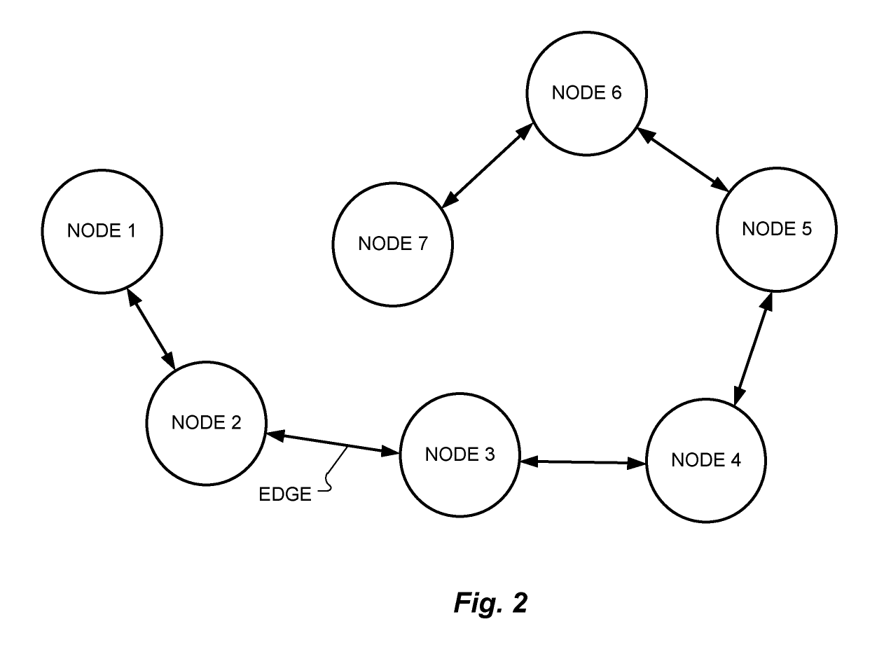

A navigation solution module 105 is configured to analyze the image sensor poses and the estimated inertial navigation solutions to produce a time sequence of system navigation solution outputs representing changing locations of the traveling vehicle. More specifically, the navigation solution module 105 may be configured as a pose graph solver to produce the system navigation solution outputs in pose graph form as shown in FIG. 2. Each node represents an image sensor pose (position and orientation) that captured the navigation image. Pairs of nodes are connected by edges that represent spatial constraints between the connected pair of nodes; for example, displacement and rotation of the image sensor 101 between the nodes. This spatial constraint is referred to as a six degree of freedom (6DoF) transform.

The pose graph solver implemented in the navigation solution module 105 may include the GTSAM toolbox (Georgia Tech Smoothing and Mapping), a BSD-licensed C++ library developed at the Georgia Institute of Technology. As the MSCKF 104 finishes with each navigation image and reports its best-and-final image sensor pose, the navigation solution module 105 creates a pose graph node containing the best-and-final pose and connects the new and previous nodes by a link containing the transform between the poses at the two nodes.

Some embodiments of the present invention include additional or different sensors, in addition to the camera. These sensors may be used to augment the MSCKF estimates. Optionally or alternatively, these sensors may be used to compensate for the lack of a scale for the sixth degree of freedom. For example, some embodiments include a velocimeter, in order to add a sensor modality to CERDEC's GPS-denied navigation sensor repertoire and/or a pedometer, to enable evaluating the navigation accuracy improvement from tightly coupling pedometry, vision and strap-down navigation rather than combining the outputs of independent visual-inertial and pedometry filters.

Although aspects of embodiments may be described with reference to flowcharts and/or block diagrams, functions, operations, decisions, etc. of all or a portion of each block, or a combination of blocks, may be combined, separated into separate operations or performed in other orders. All or a portion of each block, or a combination of blocks, may be implemented as computer program instructions (such as software), hardware (such as combinatorial logic, Application Specific Integrated Circuits (ASICs), Field-Programmable Gate Arrays (FPGAs) or other hardware), firmware or combinations thereof. Embodiments may be implemented by a processor executing, or controlled by, instructions stored in a memory. The memory may be random access memory (RAM), read-only memory (ROM), flash memory or any other memory, or combination thereof, suitable for storing control software or other instructions and data. Instructions defining the functions of the present invention may be delivered to a processor in many forms, including, but not limited to, information permanently stored on tangible non-writable storage media (e.g., read-only memory devices within a computer, such as ROM, or devices readable by a computer I/O attachment, such as CD-ROM or DVD disks), information alterably stored on tangible writable storage media (e.g., floppy disks, removable flash memory and hard drives) or information conveyed to a computer through a communication medium, including wired or wireless computer networks.

While specific parameter values may be recited in relation to disclosed embodiments, within the scope of the invention, the values of all of parameters may vary over wide ranges to suit different applications. Unless otherwise indicated in context, or would be understood by one of ordinary skill in the art, terms such as “about” mean within ±20%.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

While the invention is described through the above-described exemplary embodiments, modifications to, and variations of, the illustrated embodiments may be made without departing from the inventive concepts disclosed herein. Furthermore, disclosed aspects, or portions thereof, may be combined in ways not listed above and/or not explicitly claimed. Embodiments disclosed herein may be suitably practiced, absent any element that is not specifically disclosed herein. Accordingly, the invention should not be viewed as being limited to the disclosed embodiments.

What is claimed is:

1. A computer-implemented vision-aided inertial navigation system for determining navigation solutions for a traveling vehicle, the system comprising:
an image sensor configured for producing a time sequence of navigation images;
an inertial measurement unit (IMU) sensor configured to generate a time sequence of inertial navigation information;
data storage memory coupled to the image sensor and the inertial measurement sensor and configured for storing navigation software, the navigation images, the inertial navigation information, and other system information;
a navigation processor including at least one hardware processor coupled to the data storage memory and configured to execute the navigation software, wherein the navigation software includes processor readable instructions to implement:
a feature tracking module configured to perform optical flow analysis of the navigation images based on:
a. detecting at least one image feature patch within a given navigation image comprising a plurality of adjacent image pixels corresponding to a distinctive visual feature,
b. calculating a feature track for the at least one image feature patch across a plurality of subsequent navigation images based on calculating a tracking residual, and
c. rejecting any feature track having a tracking residual greater than a feature tracking threshold criterion that varies over time with changes in quantifiable characteristics of the at least one feature patch;
a multi-state constraint Kalman filter (MSCKF) coupled to the a feature tracking module and configured to analyze the navigation images and the unrejected feature tracks to produce a time sequence of estimated image sensor poses characterizing estimated position and orientation of the image sensor for each navigation image;
a strapdown integrator configured to integrate the inertial navigation information from the IMU to produce a time sequence of estimated inertial navigation solutions representing changing locations of the traveling vehicle;
a navigation solution module configured to analyze the image sensor poses and the estimated inertial navigation solutions to produce a time sequence of system navigation solution outputs representing changing locations of the traveling vehicle.

2. The system according to claim 1, wherein the quantifiable characteristics of the at least one feature patch include pixel contrast for image pixels in the at least one feature patch.

3. The system according to claim 1, wherein the feature tracking threshold criterion includes a product of a scalar quantity times a time-based derivative of the quantifiable characteristics.

4. The system according to claim 3, wherein the time-based derivative is a first-order average derivative.

5. The system according to claim 1, wherein the feature tracking threshold criterion includes a product of a scalar quantity times a time-based variance of the quantifiable characteristics.

6. The system according to claim 1, wherein the feature tracking threshold criterion includes a product of a first scalar quantity times a time-based variance of the quantifiable characteristics in linear combination with a second scalar quantity accounting for at least one of image noise and feature contrast offsets.

7. A computer-implemented method employing at least one hardware implemented computer processor for performing vision-aided navigation to determine navigation solutions for a traveling vehicle, the method comprising:
producing a time sequence of navigation images from an image sensor;
generating a time sequence of inertial navigation information from an inertial measurement sensor;
operating the at least one hardware processor to execute navigation software program instructions to:
perform optical flow analysis of the navigation images based on:
a) detecting at least one image feature patch within a given navigation image comprising a plurality of adjacent image pixels corresponding to a distinctive visual feature,
b) calculating a feature track for the at least one image feature patch across a plurality of subsequent navigation images based on calculating a tracking residual, and
c) rejecting any feature track having a tracking residual greater than a feature tracking threshold criterion that varies over time with changes in quantifiable characteristics of the at least one feature patch;
analyze the navigation images and the unrejected feature tracks with a multi-state constraint Kalman filter (MSCKF) to produce a time sequence of estimated image sensor poses characterizing estimated position and orientation of the image sensor for each navigation image;
analyze the inertial navigation information to produce a time sequence of estimated inertial navigation solutions representing changing locations of the traveling vehicle; and
analyze the image sensor poses and the estimated inertial navigation solutions to produce a time sequence of system navigation solution outputs representing changing locations of the traveling vehicle.

8. The method according to claim 7, wherein the quantifiable characteristics of the at least one feature patch include pixel contrast for image pixels in the at least one feature patch.

9. The method according to claim 7, wherein the feature tracking threshold criterion includes a product of a scalar quantity times a time-based derivative of the quantifiable characteristics.

10. The method according to claim 9, wherein the time-based derivative is a first-order average derivative.

11. The method according to claim 7, wherein the feature tracking threshold criterion includes a product of a scalar quantity times a time-based variance of the quantifiable characteristics.

12. The method according to claim 7, wherein the feature tracking threshold criterion includes a product of a first scalar quantity times a time-based variance of the quantifiable characteristics in linear combination with a second scalar quantity accounting for at least one of image noise and feature contrast offsets.
